(19) United States
(12) Patent Application Publication
(10) Pub. No.: US 2013/0112147 A1
(43) Pub. Date: May 9, 2013

(54) HORSE FEEDER

(71) Applicant: Robert Ernest Drury, Barrie (CA)

(72) Inventor: Robert Ernest Drury, Barrie (CA)

(21) Appl. No.: 13/322,764

(22) PCT Filed: Jul. 29, 2011
(86) PCT No.: PCT/CA2011/000883

§ 371 Date: Nov. 28, 2011

Related U.S. Application Data
(60) Provisional application No. 61/344,465, filed on Jul. 30, 2010.

(51) Int. Cl. A01K 5/00

(52) U.S. Cl. CPC A01K 5/00
USPC 119/58

(57) ABSTRACT

The present invention is directed to a feed device for feeding horses. The feed device includes a base for supporting the feed device on the ground, a divider and a cage structure. The cage structure includes a front feed wall, a rear feed wall, a first sidewall and a second sidewall, and the divider is disposed within the cage structure forming between the divider, the front feed wall, a portion of the first sidewall and a portion of the second sidewall a first feeding chamber for storing hay and forming between the divider, the rear feed wall, a further portion of the first sidewall and a further portion of the second sidewall a second feeding chamber for storing hay. The divider providing a spring force to push the hay stored within the first and second chambers towards the front and rear feed walls respectively.

### RELATED APPLICATION

The application claims the benefit of 35 USC 119(e) to United States Provisional Application Ser. No. 61/334,465 filed 30 Jul. 2010 (30.07.2010).

### SCOPE OF THE INVENTION

The present invention relates to a device for feeding livestock animals, and more particularly to a device for feeding hay to horses. More specifically, the present invention relates to an enclosure which stores hay within and includes at least one wall having a mesh-like construction which restricts the rate at which the horses may pull the hay from the enclosure.

### BACKGROUND OF THE INVENTION

Most conventional livestock feeding methods are designed solely for the ease of the livestock care givers and do not take into account healthy eating habits of the livestock. For example, horses generally only sleep about 3 to 4 hours in a 24 hour period and not longer than 20 minutes at a time, with eating generally being the horse's main focus for the remaining 20 hours. Furthermore, the majority of horses throughout the world are fed 2 to 4 times per day which can be very time consuming for the care givers.

Conventional feeding methods and devices for horses are generally designed as enclosures to hold large amounts of hay. The enclosures are provided with large openings for the horses to access the hay so they may eat freely. Accordingly, caregivers are only required to fill the enclosures with hay once they are empty, typically supplying the feeding device with 2 to 4days supply of feed. Other methods of feeding include merely dumping big round bales or big square bales of hay on the ground and allowing the horses to feed at will.

For example, United States Patent publication U.S. 2005/0217593 published Oct. 6, 2005 discloses a covered animal feeding device having an open top, a bottom, a back wall, two sidewalls and a front wall with openings through which an animal can pull hay. The feeder also has a hinged cover to protect feed within the container from moisture and has mounting brackets extending from the back wall that allow the container to be mounted to the top rail of a standard livestock fence. The hinged cover includes two sets of hinges, which allow the cover to be opened from either the front or back of the container thereby allowing a person to load the container from the opposite side of the fence on which the container is mounted and avoid entering the area enclosed by the fence.

These known traditional feeding methods and devices are generally unhealthy for a horse as the horse is allowed to eat all he wants as fast as he can without restriction. These known traditional feeding methods result in Bolus feeding habits which is not healthy for horses and which result in over eating and other health problems related to these eating habits, such as colic, sand colic, laminitis, insulin resistance, obesity and respiratory diseases caused by dust given off from the hay when horses are allowed to feed as described above. Another aspect is when the hay is allowed to touch the ground the horses defecate and pass urine on the feed of which they are eating.

Furthermore, a horse's stomach is relatively small for the size of the horse and food passes through it in as little as 12 minutes. From the stomach the food passes into the small intestine, where it only stays for about 90 minutes. This means that 90 minutes after the stomach is empty the small intestine is empty to. This creates a problem for the horse because he cannot stop the production of digestive fluids which burn the inside of the digestive system if there is no food there to absorb them. Additionally, a horse's receptors for feeling full are located in its chewing muscles—not its stomach. This makes it essential that the horse chews its feed slowly and vigorously. If the horse eats too fast, which is encouraged in traditional method of feeding, the horse will not feel content and full when he is supposed to and therefore will over eat and feel stressed. Alternately, the horse will think he is starving although he is not and this feeling will make him feel nervous, edgy and disobedient.

### SUMMARY OF INVENTION

To at least partially overcome these disadvantages, the present invention provides a horse hay feeding device which presents hay to the horse through a mesh-like feeding surface which has openings sized to limit the amount of hay which can be pulled therethrough and requires the horse to work to successively pull strands of the hay through the openings.

The applicant has appreciated that for healthy eating habits the horse hay feeding device should eliminate Bolus feeding resulting from horses being allowed to swallow large round masses of hay without restriction. The applicant has further appreciated that by slowing down the rate at which hay is supplied to the horse and making the horse work by pulling on the hay strand by strand, the horse will eat less hay and will take a longer period to chew and eat their required amounts of hay, thus remaining occupied for longer periods of time and stimulating both the horses mind and digestive system.

Accordingly, it is an object of the present invention to provide a feeding device which promotes healthy eating habits in livestock and which eliminates Bolus feeding.

It is a further object of the present invention to provide a feeding device which provides smaller amounts of hay to a horse so that the horse is required to chew the hay much more thoroughly, properly preparing the food for the horses digestion system.

It is a further object of the present invention to provide a feeding device which restricts the rate at which a horse will eat its feed.

It is a further object of the present invention to provide a feeding device that restricts the amount of hay a horse will put in its mouth at a time from the feeding device, thereby forcing the horse to work for its food.

It is a further object of the present invention to provide a feeding device which allows for constant feeding with minimal maintenance and supervision of the livestock and which could provide enough feed for up to 7 days, this would depend on the number of feeders utilized and the size of the herd of horses. An example of the present invention is that one feeder will hold approximately 100 lbs of hay therefore one horse will consume through the feeder approximately 20-22 lbs per day, thus enough for 5 days without refilling.

The present invention not only results in healthier eating habits for horses, but also improves the social behaviour of interacting horses in a herd. In the inventor's experience it takes about 2 to 8 weeks for the horses to start believing that the hay is growing in the feeder just like grass in the pasture. The horse is much more likely to stop guarding the feeder against his herd mates and harmony is established after this short period of adjustment.

The inventor has further experienced that the feeders of the present invention allows for the horses to continuously chew their feed, mirroring a horse's natural behaviour in the wild or on a pasture.

The following is a list of advantages that the inventor has noted with horses which feed from a device according to the present invention:
1. Improvements in the horses overall health and well being. Constant supply and restriction on the rate of feeding will in most cases stop such vices as; cribbing, weaving, aggression and feed anxiety and medically problems such as colic, sand colic, laminitis, insulin resistance and obesity. All these problems relate to Bolus feeding habits instead of natural grazing habits.
2. Reduction in the sugar a horse will eat, therefore improving body weight and hoof health. Hay contains 14-18% Nonstructural Carbohydrates (NSC).
During experimental trials with the feed device of the present invention, that inventor has experienced that horses eating from the device of the present invention will eat less hay then if the horse is given free choice hay. In trial experiments, 7 horses weighing from 800-1200 lbs were given free choice hay for a period of 20 days and it was found that these horses typically ate between 30 to 35 lbs. per day. NOTE “this is hay that was actually eaten not wasted”. Reference may now be had to the work done by the Department of Animal Sciences, University of Kentucky, which shows the amount of hay a horse actually requires to live a healthy life and not become obese.
Based on scientific evaluation, these horses should on average be a healthy weight of approximately 900 lbs. Accordingly, the maximum amount of hay required by these horses to maintain a healthy weight would be about 18-20 lbs. per day. Based on 16% NSC horses allowed free choice non restricted feed (eating 35 lbs. per day) would actually consume 5.6 lbs. of sugar a day, thus leading to obesity, founder and many other insulin related problems.
With the feeder of the present invention, it was found that these horses consumed between 20 to 22 lbs. per day, down from the 35 lbs. a day which they were consuming given free choice hay. According, the amount of NSC consumed was reduced to 3.2-3.5 lbs. per day, which resulted in these horses having a reduced weight and no longer experiencing hoof related problems.
4. Cost savings. As noted above, the reduction in the amount of feed a horse consumes results in cost saving on feed.
5. Reduction of labour at feeding times.
6. Dust free feeding; no more watering down dusty hay.
7. Reduced Veterinary Fees.
8. Wastage will be reduced from 20-50% to less than 1%.
9. The feeders of the present invention closely mirror the way a horse naturally feeds in nature. The present invention allows for the horse to eat with his head down. Horses in their natural environment eat with their heads down. This position allows nasal passages to drain and permits them to see 360 degrees, which being a prey animal being able to see at all times is vital to their survival and brings them piece while eating.

In one aspect of the invention, there is provided an enclosure for storing hay for feeding horses. The enclosure includes a front feeder wall having a mesh construction forming a plurality of openings sized and configured to allow strands of hay to extend from an inside of the enclosure through the opening of the front feeder wall. The openings allowing for a continuous supply of hay to be provided to the horse while restricting the rate at which the horse may pull the hay from the inside of the enclosure, forcing the horse to work to pull the stored hay strand by strand from the enclosure thereby simulating a horse's natural feeding habits of pulling and chewing grass on a pasture.

In a further aspect of the invention, there is provided a box-like enclosure for storing hay. The enclosure having two opposing vertically extending sidewalls, a front feeder wall having a mesh-like construction and a back wall opposing the front feeder wall and sloping downwardly from an uppermost portion to a lowermost portion towards the front feeder wall so as to reduce the space between the front and back walls from the uppermost portion of the front wall and back wall to the lowermost portion of the front and back wall forming a funnel shaped enclosure. The back wall guiding and urging the hay stored within the enclosure towards the front feeder wall so that strands of the stored hay extend from an interior of the enclosure through the mesh-like front feeder wall.

In a further aspect of the invention, there is provided an enclosure having a chamber for storing hay. The chamber including a front feeder wall having a mesh-like construction having openings and a back wall opposing the front feeder wall and sloping downwardly from an uppermost portion to a lowermost portion towards the front feeder wall so as to reduce the space between the front and back walls from the uppermost portion of the front and back walls to the lowermost portion of the front and back walls. The back wall guiding and urging the hay stored within the chamber towards the front feeder wall so that strands of the stored hay extend from an interior of the chamber through the opening of the front feeder wall.

In a further aspect of the invention, there is provided a feeder device for feeding livestock animals. The device includes a chamber for storing hay and at least one feeder wall comprising a plurality of inner bars disposed in parallel in a first direction and a plurality of outer bars disposed in parallel in a second direction substantially orthogonal to the first direction. The bars forming a grid-like pattern of openings for allowing the livestock animals to access the hay stored within the feed device. The first bars being arranged to guide the hay downwardly toward a base of the feeder device. The second bars being arranged to allow strands of the strand hay to pass to an outside of the feeder device.

In a further aspect of the invention there is provided a box shaped feeding enclosure having four vertically extending walls for storing hay. At least one of said walls comprising a mesh-like structure having a plurality of openings for horses to access the hay stored therein. The mesh-like structure including a plurality of first bars disposed in parallel in a first direction and a plurality of second bars disposed in parallel in a second direction substantially orthogonal to the first direction.

In a yet further aspect of the invention there is provided a feed device for feeding horses. The feed device includes a feed chamber for storing hay having a front feeder wall and an opposing downwardly sloping divider for providing a force to push the stored hay outwardly towards the front feeder wall. The feeder wall having openings for allowing horses to access the stored hay and comprising a plurality of first bars disposed in parallel in a first direction and a plurality of second bars disposed in parallel in a second direction substantially orthogonal to the first direction forming a grid-like pattern.

In yet a further aspect of the invention there is provided a feed device comprising a base, a cover and a cage structure. The cage structure includes four vertical walls arranged in a square with a first front feeder wall, a second sidewall, a third rear feeder wall and a fourth sidewall. Within the cage structure there is provided an inverted V-shaped divider which forms together with the vertical walls two distinct feed compartments within the cage structure including a first feed chamber and a second feed chamber. The vertical walls comprising a plurality of vertically disposed bars and a plurality of horizontally disposed bars forming a plurality of openings for the horse to access hay stored within the first and second feed chambers.

In a yet further aspect of the invention there is provided a feed device for feeding horses. The feed device comprises a base, a cover, a divider and a cage structure forming an enclosure for storing hay. The cage structure includes a front feeder wall, a rear feeder wall, a first sidewall, and a second sidewall. The divider being disposed within the cage structure in an inverted V-shape forming together with the walls of the cage structure distinct first and second feed chambers within the cage structure for storing the hay and providing a force to push the stored hay outwardly towards the front and rear walls respectively. The walls comprising a plurality of inner bars disposed vertically and a plurality of outer bars disposed horizontally and spaced outwardly of the vertically disposed bars and forming a plurality of openings allowing for strands of hay stored within the first and second feed chambers to extend therefrom to an outside of the feed device.

In yet a further aspect of the invention, there is provided a feed device for feeding horses, the feed device comprises: a base for supporting the feed device on the ground; a divider; and a cage structure, said cage structure comprising a front feed wall, a rear feed wall, a first sidewall and a second sidewall; wherein the divider being disposed within the cage structure forming between the divider, the front feed wall, a portion of the first sidewall and a portion of the second sidewall a first feeding chamber for storing hay and forming between the divider, the rear feed wall, a further portion of the first sidewall and a further portion of the second sidewall a second feeding chamber for storing hay; said divider providing a spring force to push the hay stored within the first and second chambers towards the front and rear feed walls respectively; wherein the front feed wall and the rear feed wall comprises a plurality of first bars disposed in parallel in a first direction and a plurality of second bars spaced outwardly of the first bars and disposed in parallel in a second direction, said first and second bars forming a plurality of openings allowing for strands of hay stored within the first and second feed chambers to extend therefrom to an outside of the feed device.

In yet a further aspect of the present invention, there is provided a device for feeding live stock animals, the device comprising: a chamber for storing hay, the chamber comprising a front feeder wall having a plurality of openings, the openings being sized to allow strands of the stored hay to pass from the chamber to an outside of the device; and a back wall for providing a force to push the stored hay outwardly towards the front feeder wall, the back wall sloping downwardly towards the front feeder wall from an uppermost portion to a lowermost portion so as to reduce the space between the front and back walls from the uppermost portion to the lowermost portion of the front and back walls.

### BRIEF DESCRIPTION OF THE DRAWINGS

Reference may now be had to the following detailed description taken together with the accompanying drawings in which:

FIG. 1 shows a side elevation view of a first preferred embodiment of a horse feeder in accordance with the present invention.

FIG. 2 shows a side elevation view of the horse feeder shown in FIG. 1 which is partially filled with hay.

FIG. 3 shows a front elevation view of the horse feeder shown in FIG. 1 which is partially filled with hay.

FIG. 4 shows an enlarged view of a mesh construction of a wall of a cage structure in accordance with the present invention.

FIG. 5 shows a top plan view of two integrally formed walls of a cage structure in accordance with the present invention.

FIG. 6 shows an enlarged view of a base of a feeder in accordance with the present invention.

FIG. 7 shows a side perspective view of the feeder shown in FIG. 1.

FIG. 8 shows a perspective view of a horse feeder device in accordance with a second embodiment of the present invention.

FIG. 9 shows a top plan view of the horse feeder device shown in FIG. 8.

FIG. 10 shows an enlarged view of the base of the horse feeder device shown in FIG. 8.

FIG. 11 shows a second perspective view of the horse feeder device shown in FIG. 9.

### DETAILED DESCRIPTION OF THE DRAWINGS

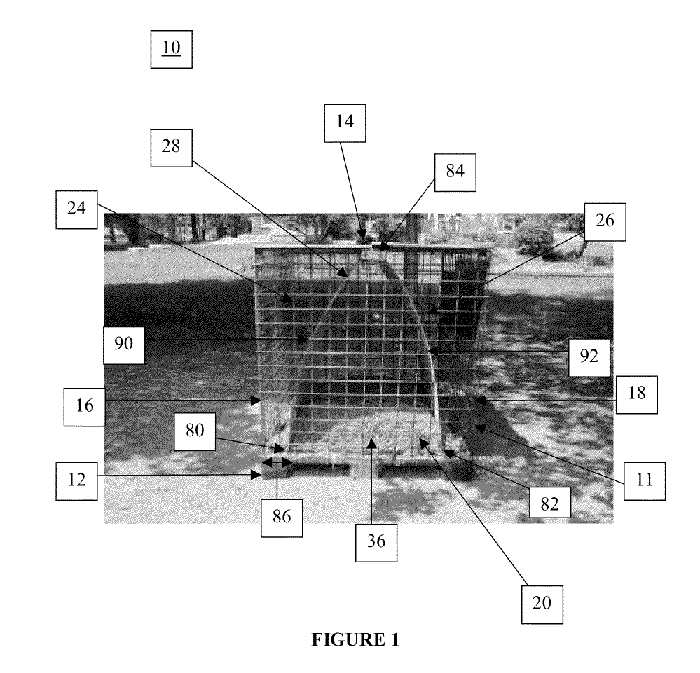

Reference may now be made to FIG. 1 which illustrates a preferred embodiment of the feeder 10 of the present invention. The feeder 10 is a box-like enclosure which includes a base 12, a cover 14 and a cage structure 11. The cage structure 11 includes four vertical walls arranged in a rectangle with a front feeder wall 16, a rear feeder wall 18, a first sidewall 20 and a second sidewall 22.

An interior space is defined within the walls 16, 18, 20 and 22 of the cage structure 11. Within the interior space of the cage structure 11 there is an inverted V-shaped divider 28 having two integrally formed panels including a first panel 90 and a second panel 92. The divider 28 is positioned within the interior space of the cage structure 11 so that the first and second panels 90 and 92 form an apex 84 positioned near a top portion of the interior space and extends along a lateral centerline from the first sidewall 20 to the second sidewall 22. The first panel 90 extends downwardly from the apex 84 sloping toward the front feeder wall 16 so that a first end 80 of the divider 28 is arranged on the base 12 adjacent to a bottom portion of the front feeder wall 16. The panel 90 having an outwardly facing surface opposed to the front feeder wall 16. The second panel 92 extends downwardly from the apex 84 sloping towards the rear feeder wall 18 so that a second end 82 of the divider 28 is arranged on the base 12 adjacent to a bottom portion of the rear feeder wall 18. The panel 92 having an outwardly facing surface opposed to the rear feeder wall 18.

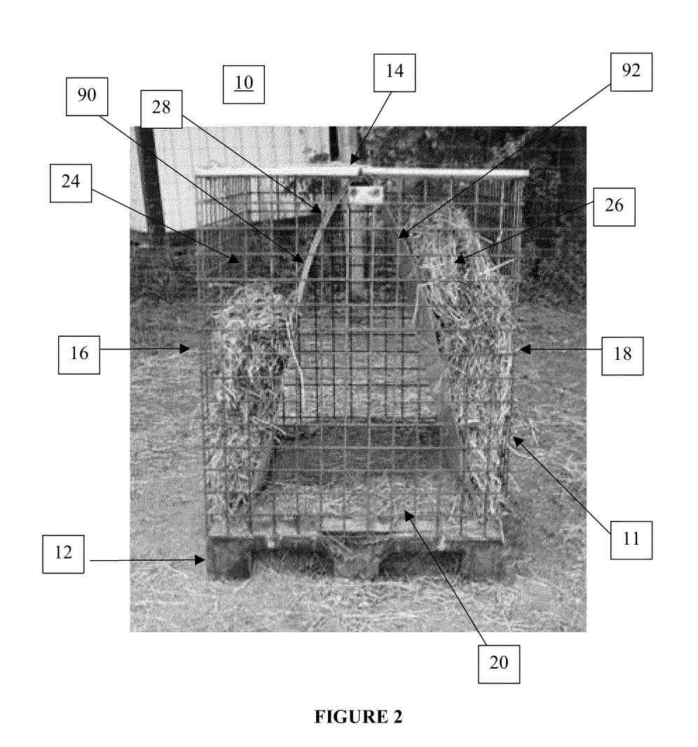

As shown in FIG. 2, which shows a side elevation view of the feeder 10 of FIG. 1 partially filled with hay, the divider 28 together with the walls 16, 18, 20 and 22 of the cage structure 11 divide the interior space of the cage structure 11 to form a first feed chamber 24 and a second feed chamber 26. The first feed chamber 24 being formed between the front feeder wall 16, the first panel 90, a portion of the first sidewall 20 and a portion of the second sidewall 22. The second feed chamber 26 being formed between the rear feeder wall 18, the second panel 92, a further portion of the first sidewall 20 and a further portion of the second sidewall 22.

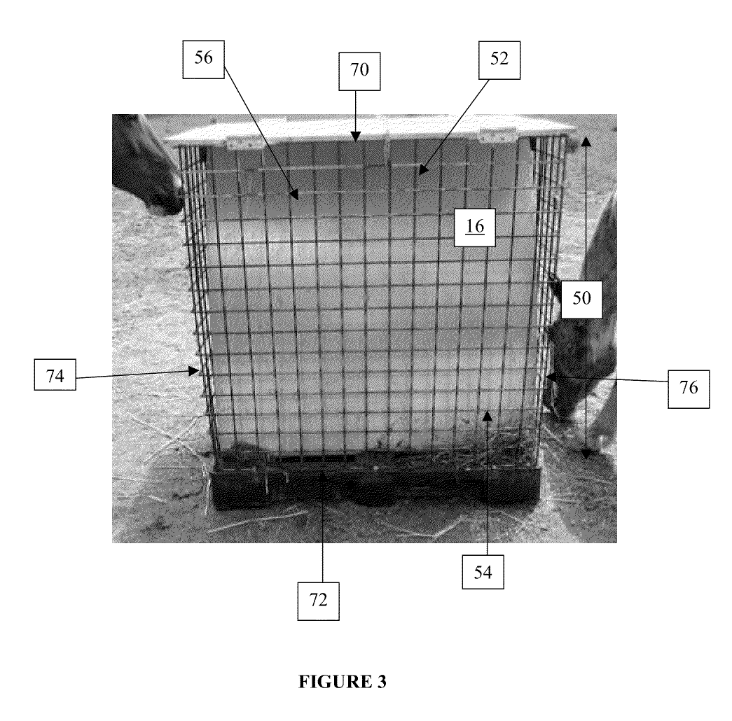

As will be more fully described below, the downwardly sloping angle of the panels 90 and 92 function to provide a funnelling force to guide and urge the hay stored within the respective feeding chamber 24 and 26 downwardly and outwardly towards the front feeder wall 16 and rear feeder wall 18 respectively. As shown in FIG. 3, which will be more fully described below, the walls 16, 18, 20 and 22 of the cage structure 11 have a mesh-like construction which forms a plurality of openings 56 sized and configured to allow strands of hay stored within the feeding chambers 24 and 26 to extend through the front feeder wall 16 and rear feeder wall 18 to an outside of the feeder 10. Accordingly, in use, the feeder 10 provides a continuous supply of hay to the horse while requiring the horses to work to pull the strands of hay from the feeder 10 strand by strand thereby simulating a horse's natural feeding habit.

It is to be understood that the walls 16, 18, 20 and 22 of the cage structure 11 may be formed integrally as a single structure or alternatively formed as separate and distinct walls which are secured together.

The following more detailed description will be restricted to the front feeder wall 16 which should be understood as being equally applicable to the rear feeder wall 18. It is to be further understood that each of the walls 20 and 22 may also have a similar construction as described or alternatively may be provided as solid sheet members having no openings.

The front feeder wall 16 shown in FIG. 3 has a generally rectangular shape having a top edge 70, a bottom edge 72, a first side edge 74 and a second side edge 76. The front feeder wall 16 has a width extending from the first side edge 74 to the second side edge 76 which substantially corresponds to the width of the base 12, and a vertically height 50 extending from the top edge 70 to the bottom edge 72 ranging from 42 inches to 52 inches.

The front feeder wall 16 comprises a mesh construction having a grid-like pattern formed from a plurality of bars 52 generally vertically disposed in parallel extending from the bottom edge 72 to the top edge 70 and a plurality of bars 54 generally horizontally disposed in parallel extending from the first side edge 74 to the second side edge 76.

The grid-like pattern of the front feeder wall 16 provides a plurality of rectangular feeding openings 56 which allows for strands of hay stored within the feeding chamber 24 to extend through the openings 56 to an outside of the feeder 10.

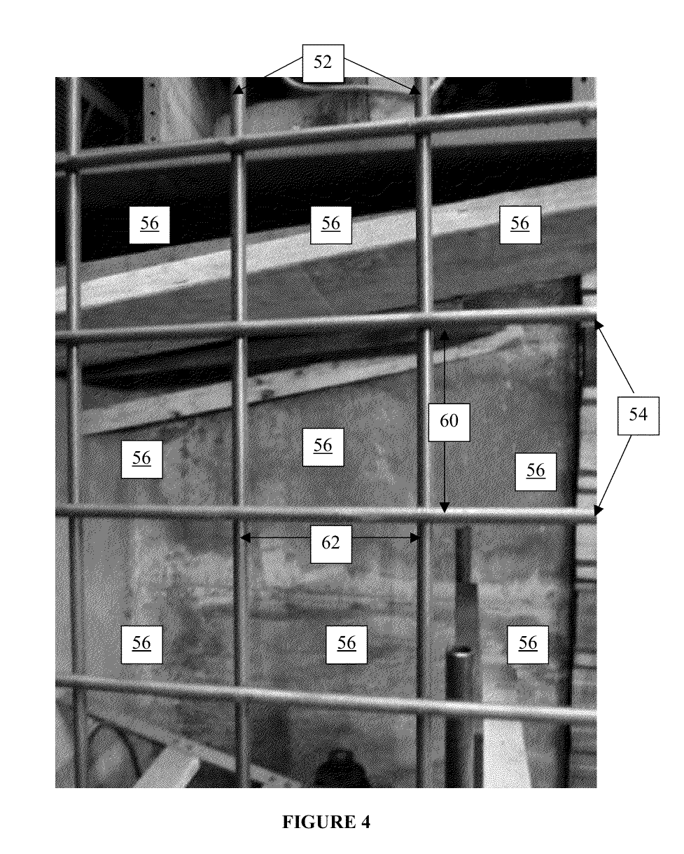

As shown in FIG. 4, the mesh construction of the front feeder wall 16 in accordance with the present invention includes openings 56 generally having a cross sectional area defined by a height 60 and a width 62 ranging from about 1.0 inches to 4 inches and more preferably 1.75 inches to 3.5 inches. In a preferred construction the bars 52 and 54 have a diameter ranging from 3/16 inches to ⅜ inches which facilitates the hay extending through the openings.

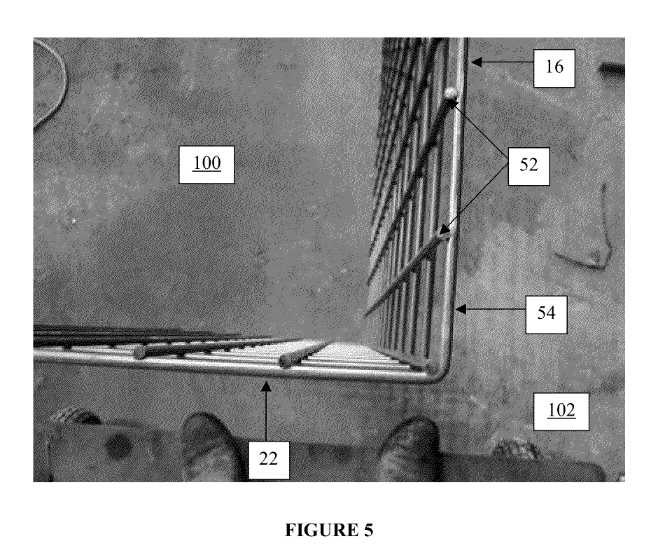

Reference may now be made to FIG. 5 which shows a top perspective view of a front feeder wall 16 and second sidewall 22 integrally formed and which may be used in the construction of the present invention. As shown, the vertically disposed bars 52 are arranged to be spaced towards an inside 100 of the feeder 10 and the horizontally disposed bars 54 are arranged to be spaced toward an outer side 102 of the feeder 10. The vertically disposed bars 52 guide the hay contained in the feed chamber downwardly towards a top surface 36 of the base 12. It is to be understood that the bars 52 may also be arranged diagonally, sloping downwardly in a vertical plane which would also facilitate guiding the hay downwardly towards the base 12.

The horizontally disposed bars 54 are spaced toward the outer side 102 of the feeder and are configured to restrict the horses from freely accessing the hay stored within the feeding chamber 24. It is to be further appreciated that the horizontally disposed bars 54 need not be positioned to abut the vertically disposed bars 52. Rather, bars 54 may be spaced away from the vertically disposed bars 52 by spacers (not shown) as desired to position the horses further away from the hay stored within the feeder 10. The bars 54 may also be provided diagonally in a vertical plane orthogonal to the bars 52, so as to form opening 56 shift by an angle of 45°, as for example diamond shaped.

Reference may now be made to FIG. 1 to more fully describe the divider 28 construction of the present invention. The divider 28 is provided within the cage structure 11 to compartmentalize the inside of the feeder 10 into the two separate feeding chambers 24 and 26. In a preferred construction, the divider 28 is a single sheet of material, and more preferably a flexible metallic or polymer based sheet material, such as a high density polyethylene material. Preferably, the divider has a thickness being less than 1 inch and more preferably ranging from 1/16 inch to ⅜ inch and a length ranging from 36 inches to 54 inches and a width which substantially corresponds to the width of the feeder 10 and typically ranges from 27 inches to 31 inches.

In the preferred construction shown, the divider 28 is a thin metal plate which extends from the first end 80 to the second end 82. The divider is arranged within the feeder 10 as an inverted V-shape having the apex 84 secured at the upper region of the feeder 10. Panel 90 of the divider 28 extends downwardly from the apex 84 towards the base 12 to the first end 80 positioned near the front feeder wall 16. Panel 92 of the divider 28 extends downwardly from the apex 84 towards the base 12 to the second end 82 positioned near the rear feeder wall 18. Preferably, the first and second ends 80 and 82 are spaced away from their respective walls 16 and 18 a distance 86 ranging from about 3 to 8 inches, and more preferably from 4 inches to 6 inches.

The panels 90 and 92 function to urge the hay stored within the feeding chambers 24 and 26 outwardly towards the front feeder wall 16 and the rear feeder wall 18 respectively, so that the hay stored within the chambers is presented to the horses near the meshed feeder walls 16 and 18. In a preferred construction the panels 90 and 92 are under compression when installed within the cage structure 11 so that the panels 90 and 92 bow outwardly towards the feeder walls 16 and 18, respectively. The bowed outwardly facing convex configuration of the panels 90 and 92 provide an outward spring force when the chambers 24 and 26 are filled with hay and urge the stored hay towards the feeding chambers 24 and 26 outwardly towards the front feeder wall 16 and the rear feeder wall 18 respectively. Through the combination of gravitational and spring forces, the hay stored within the feeder 10 is forced toward the front and rear feeder walls respectively so that strands of hay extends there through for the horses to pull and eat.

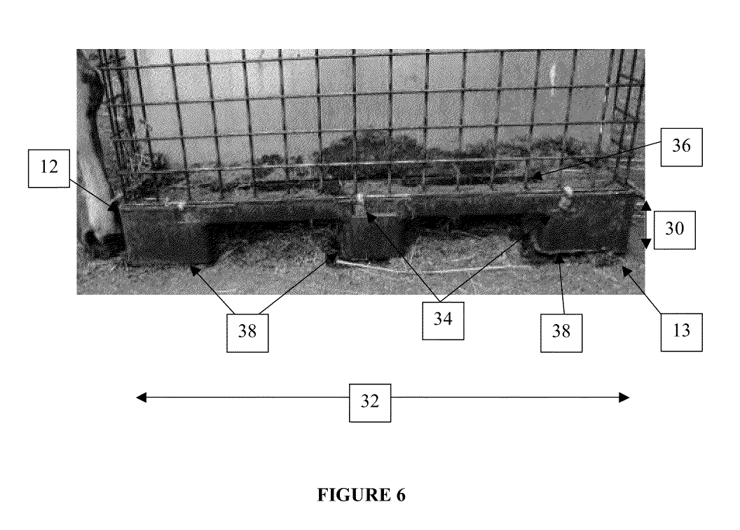

Reference is now made to FIG. 6 which shows the base 12 of the feeder 10. The base 12 is provided to support the feeder 10 when the feeder 10 is placed on the ground 13. The base 12 is of generally rectangular construction having a length and width 32 ranging from 54 inches to 40 inches. The base 12 includes a top surface 36 and legs 38 extending downwardly therefrom. The top surface 36 provides a floor for hay stored within the first feed chamber 24 and the second feed chamber 26. In the preferred construction shown, the legs 38 are formed integrally with the top surface 36. The legs 38 have a height 30 so that the top surface 36 of the feeder is sufficiently distanced above the ground 13 to prevent the horses from feeding too closely to the ground 13. Preferably the height 30 is at least 5 inches. The base 12 may be provided with clips 34 to affix or secure the walls 16, 18, 20 and 22 of the cage structure 11 to the base 12. The base 12 may also be provided with tracks (not shown) to receive lower end portions of the walls 16, 18, 20 and 22 for positioning and affixing the cage structure 11 to the base 12.

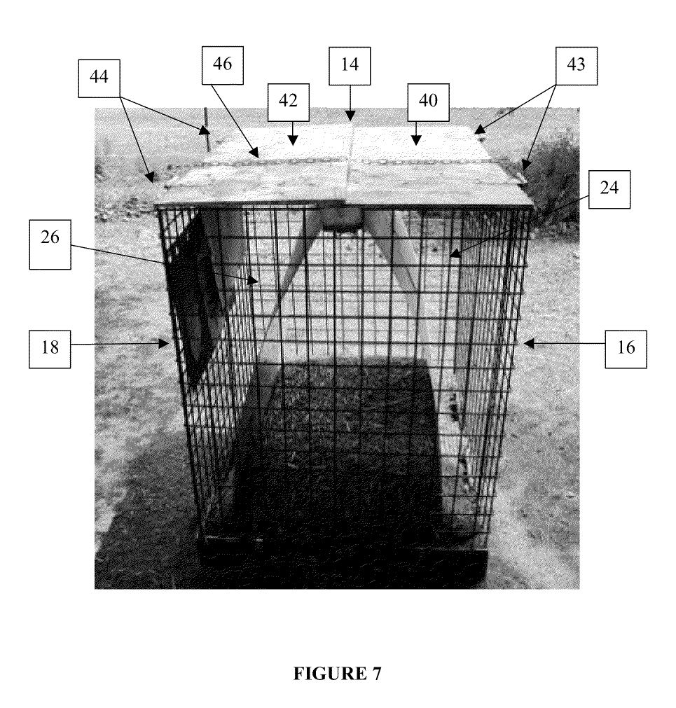

Reference is now made to FIG. 7 which shows an elevated side view of the feeder 10 shown in FIG. 1. The feeder 10 is provided with a cover 14 for covering the feeder 10. The cover 14 operates to protect the feed within the feeder 10 from the environment, such as sun, rain or snow. In the preferred construction shown, the cover 14 includes two separate hinged mounted closure members 40 and 42. The closure member 40 is hinge mounted to the front feeder wall 16 at hinges 43 and closure member 42 is hinged mounted to the rear feeder wall 18 at hinges 44. Closure member 40 may be pivoted about the hinges 43 to provide access to the feeding chamber 24 and closure member 42 may be pivoted about the hinges 44 to provide access to the feeding chamber 26 so that the feeding chambers 24 and 26 may be filled with hay as shown in FIG. 2. The cover 14 is also preferably provided with a locking mechanism 46 shown as a chain to prevent the closure members 40 and 42 from opening when not desired. The cover 14 may preferably be made of wood, plastic, metal or any other suitable materials.

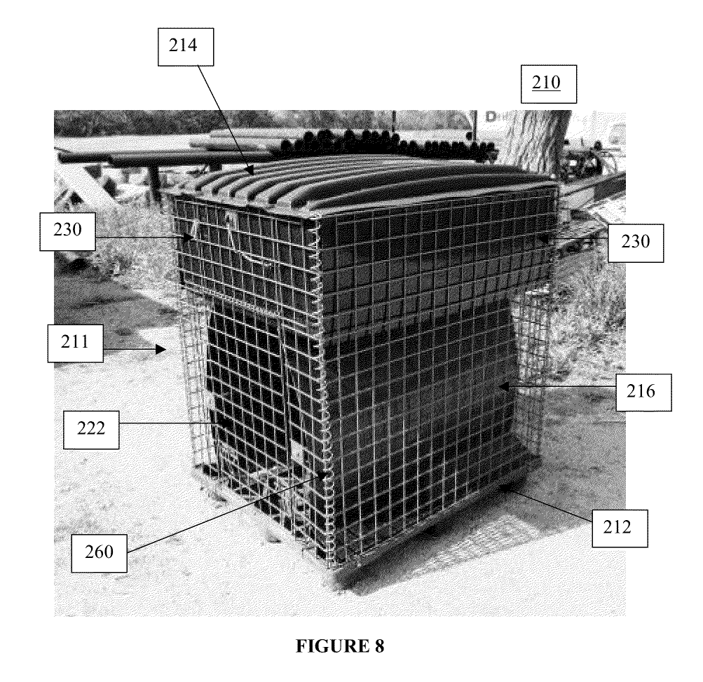

Reference may now be made to FIG. 8 which shows a second embodiment of a horse feeder 210 in accordance with the present invention. The following detailed description of the feeder 210 will focus on the differences over those of the feeder 10 detailed above. The feeder 210 includes a base 212, a cover 214, a divider 228 and a cage structure 211. The cage structure 211 includes four vertical walls arranged in a rectangle with a front feeder wall 216, a rear feeder wall 218, a first sidewall 220 and a second sidewall 222. Each of the front feeder wall 216, the rear feeder wall 218, the first sidewall 20 and the second sidewall 22 are coupled to one another, respectively, by a helical fastener 260. The helical fastener 260 facilitates the assembly and transportation of the feeder 210.

The cover 214 is provided as a single member hinge mounted to the first sidewall 220 of the cage structure 211 and is arranged to cover the entire top surface of the feeder 210. The single piece cover member 214 may also be made to friction fit over the cage structure 211 of the feeder 220, which would not require any hinges.

The feeder 220 is provided with upper skirting 230 which are arranged on and in an upper area of each vertical wall 216, 218, 220 and 222 of the cage structure 211. Each skirting has a width which substantially corresponds to the width of a respective wall 216, 218, 220 and 222 and a height ranging from 10 inches to 36 inches. The skirting 230 are provided to restrict the horse's access to the hay stored in respective feeding chambers. The provision of the skirting 230 force the horses to pull the hay stored in the feeder 210 from a lower portion of the feeding walls, requiring the horses to eat with their heads down at an appropriate height, simulating a horse's natural feeding position.

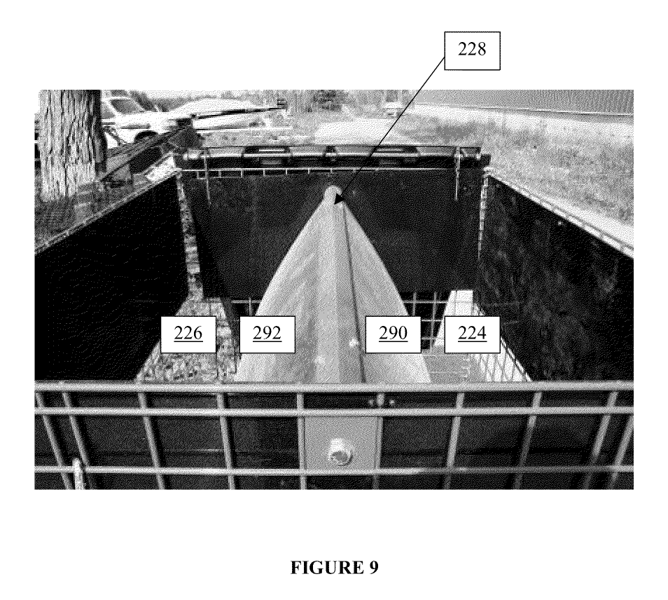

As shown in FIG. 9, the divider 228 includes a first panel 290 and a second panel 292 arranged within the cage structure 211 to compartmentalize the inside of the feeder 210 into two separate feeding chambers 224 and 226, respectively. Upper ends of the panel 290 and panel 292 are fixed to a longitudinally extending bracket 228 which also provides structural stability to the cage structure 211.

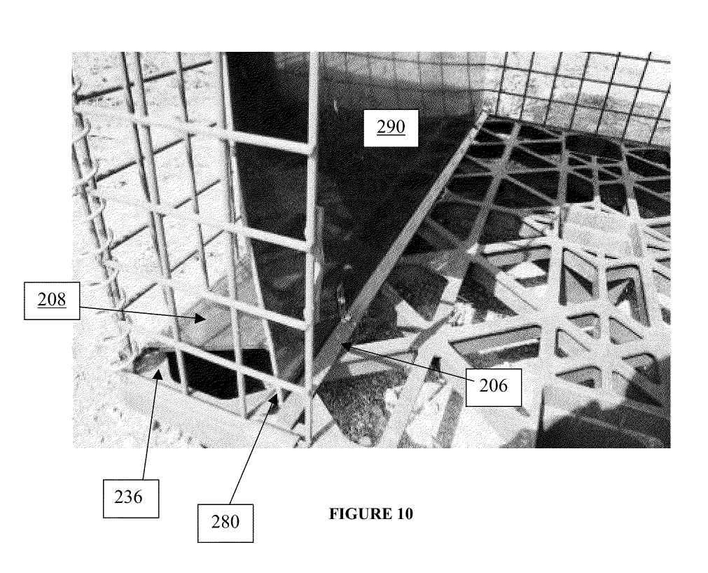

As shown in FIG. 10, the top surface 236 of the base 212 is provided with a longitudinally extending channel 206 formed to slidably receive a first end 280 of the first panel 290. Similarly, the base is provided with a second longitudinally extending channel formed to slidably receive a first end of the second panel 292 (not shown). Each of the feeding chambers 224 and 226 are provided with an angled floor guide 208 which slopes downwardly from the divider 228 towards respective feeder walls 216 and 218. The guide 208 ensures that the hay is completely consumed and that the hay does not sit on the bottom of the feeding chambers 224 and 226, respectively.

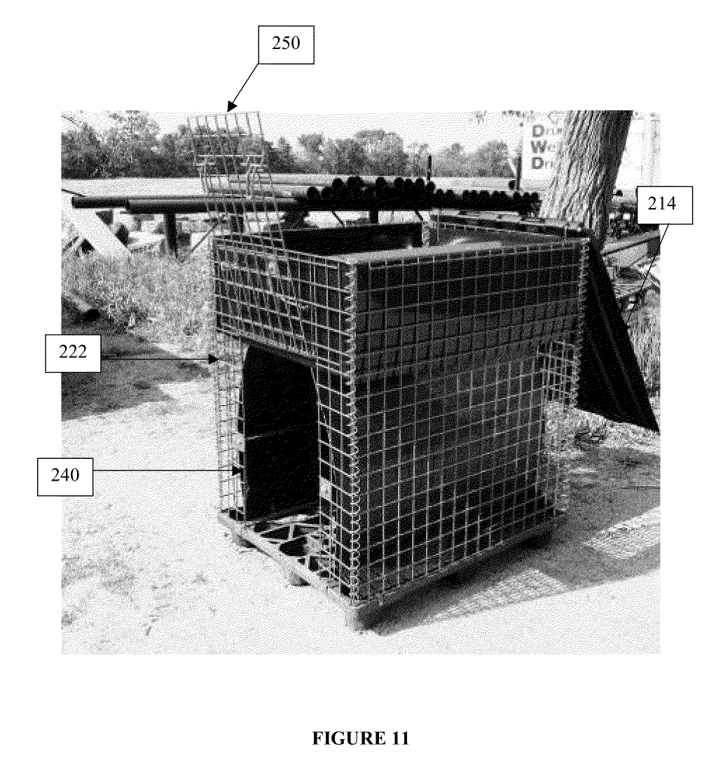

As shown in FIG. 11, the second side wall 222 is provided with an opening 240 to an interior space formed between the panel 290 and the panel 292 of the divider 228. The opening is provided with a door 250 hinge mounted to the second side wall 222. The interior space formed between the panel 290 and the panel 292 advantageously provides additional storage space compartment to store extra bales of hay.

Although this disclosure has described and illustrated certain preferred embodiments of the present invention, it is also to be understood that the invention is not restricted to these particular embodiments. For example, in an alternative embodiment, the feeder 10 may only be provided with one feed chamber 24 formed between a front feeder wall, a back divider wall and two sidewalls.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments, which are functional, electrical or mechanical equivalents of the specific embodiments and features that have been described and illustrated herein.

1. A feed device for feeding horses, the feed device comprises:
a base for supporting the feed device on the ground;
a divider; and
a cage structure, said cage structure comprising a front feed wall, a rear feed wall, a first sidewall and a second sidewall;
wherein the divider being disposed within the cage structure forming between the divider, the front feed wall, a portion of the first sidewall and a portion of the second sidewall a first feeding chamber for storing hay and forming between the divider, the rear feed wall, a further portion of the first sidewall and a further portion of the second sidewall a second feeding chamber for storing hay; said divider providing a spring force to push the hay stored within the first and second chambers towards the front and rear feed walls respectively;
wherein the front feed wall and the rear feed wall comprises a plurality of first bars disposed in parallel in a first direction and a plurality of second bars spaced outwardly of the first bars and disposed in parallel in a second direction, said first and second bars forming a plurality of openings allowing for strands of hay stored within the first and second feed chambers to extend therefrom to an outside of the feed device.

2. The feed device according to claim 1, further comprising a cover for covering the cage structure.

3. The feed device according to claim 1, wherein the divider is disposed in the cage structure in an inverted V-shape with an apex of the divider being positioned in an upper portion of the cage structure and extending from the first sidewall to the second sidewall, wherein the divider extends from a first end to a second end with the first end being positioned on the base proximal to the front feed wall and the second end being positioned on the base proximal to the rear feed wall.

4. The feed device according to claim 3, wherein the divider comprises a first panel extending from the apex to the first end, and a second panel extending from the apex to the second end, wherein the first panel includes an outwardly bowed surface opposing the front feed wall and the second panel includes an outwardly bowed surface opposing the rear feed wall.

5. The feed device according to claim 1, wherein the divider is integrally formed.

6. The feed device according to claim 1, wherein the divider is formed from a single piece of sheet material.

7. The feed device according to claim 6, wherein the sheet material is selected from sheet metal and a polymer based sheet material.

8. The feed device according to claim 1, wherein the first direction is generally vertical.

9. The feed device according to claim 1, wherein the opening are sized to have a cross sectional area defined by a height ranging from 1.75 inches to 3.5 inches and a width ranging from 1.75 inches to 3.5 inches.

10. The feed device according to claim 1, wherein the front feed wall and the rear feed wall are respectively coupled to the first sidewall and the second sidewall by a helical fastener.

11. The feed device according to claim 1, wherein at least one of the first sidewall and the second sidewall comprise an opening to a third chamber formed between the first and second panels, said opening being provided with a closure means.

12. A device for feeding live stock animals, the device comprising:
a chamber for storing hay, the chamber comprising
a front feeder wall having a plurality of openings, the openings being sized to allow strands of the stored hay to pass from the chamber to an outside of the device; and
a back wall for providing a force to push the stored hay outwardly towards the front feeder wall, the back wall sloping downwardly towards the front feeder wall from an uppermost portion to a lowermost portion so as to reduce the space between the front and back walls from the uppermost portion to the lowermost portion of the front and back walls.

13. The device according to claim 12, wherein the front feeder wall comprises a plurality of first bars disposed in parallel in a first direction and a plurality of second bars disposed in parallel in a second direction substantially orthogonal to the first direction forming a grid-like pattern.

14. The device according to claim 12, wherein the back wall comprises a surface opposing the front feeder wall, the surface being outwardly bowed towards the front feeder wall.

15. The device according to claim 12, wherein the back wall is formed from a single piece of sheet material, wherein the sheet material is selected from one of sheet metal and a polymer based sheet material.

16. The device according to claim 12, wherein the first direction is generally vertical.

17. The device according claim 12, wherein the opening are sized to have a cross sectional area defined by a height ranging from 1.75 inches to 3.5 inches and a width ranging from 1.75 inches to 3.5 inches.
